(19) United States
(12) Patent Application Publication
(10) Pub. No.: US 2014/0340328 A1
(43) Pub. Date: Nov. 20, 2014

(54) DRAWING APPARATUS AND DRAWING SYSTEM

(71) Applicant: KABUSHIKI KAISHA TOSHIBA, Tokyo (JP)

(72) Inventors: Kenichi KAMEYAMA, Tokyo (JP); Daisuke YAMAMOTO, Kawasaki-shi (JP); Junya TAKAKURA, Kawasaki-shi (JP)

(73) Assignee: KABUSHIKI KAISHA TOSHIBA, Tokyo (JP)

(21) Appl. No.: 14/197,972

(22) Filed: Mar. 5, 2014

(30) Foreign Application Priority Data
May 14, 2013 (JP) 2013-102606

(51) Int. Cl. G06F 3/0354; G06F 3/16; G06F 3/01

(52) U.S. Cl. CPC G06F 3/03545; G06F 3/016; G06F 3/16
USPC 345/173; 345/179

(57) ABSTRACT

According to an embodiment, a drawing apparatus includes a drive unit, a distance acquisition unit, and a drive controller. The drive unit vibrates the drawing apparatus. The distance acquisition unit acquires a distance between the drawing apparatus and a device. The drive controller drives the drive unit at a first amplitude when: the drawing apparatus is in a drawing mode, the drawing apparatus and the device are determined to be within a first distance based on the acquired distance, and the drawing apparatus is determined to be moving. The drive controller drives the drive unit at a second amplitude greater than the first amplitude when: the drawing apparatus is in the drawing mode, the drawing apparatus and the device are determined to be in contact with each other based on the acquired distance, and the drawing apparatus is determined to be moving.

### CROSS-REFERENCE TO RELATED APPLICATION(S)

This application is based upon and claims the benefit of priority from Japanese Patent Application No. 2013-102606, filed on May 14, 2013; the entire contents of which are incorporated herein by reference.

### FIELD

Embodiments described herein relate generally to a drawing apparatus and a drawing system.

### BACKGROUND

In a mobile terminal such as a tablet, there is known a technology in which when an operation is performed by directly touching a screen with a finger or a touch pen, adequate vibration is given to develop a tactile sense of drawing in a pseudo manner. For example, there is known a technology in which when a user moves his or her finger along a screen surface, adequate vibration is added on a screen in a horizontal direction so that a user experiences a tactile feeling approximated to that of a concavo-convex shape. Also, there is promoted a method in which a tactile sense is utilized to provide a feedback to an action of operating a button on a screen or to present an end or a specific area on a screen.

### BRIEF DESCRIPTION OF THE DRAWINGS

FIG. 1 is a diagram illustrating a hardware configuration of a drawing apparatus according to an embodiment;

FIG. 2 is a diagram illustrating a configuration of an attachment to be mounted to a drawing apparatus according to an embodiment;

FIGS. 3A to 3C are diagrams illustrating aspects of contact of a brush part with a screen in a drawing apparatus according to an embodiment;

FIG. 4 is a flow chart illustrating a flow of processing for controlling vibration of a touch pen according to an embodiment;

FIG. 5 is a diagram for explaining that a brush stroke varies in thickness depending on a positional relationship between a touch pen and a screen;

FIGS. 6A to 6C are diagrams illustrating a determination method of a marker position of a touch pen according to an embodiment;

FIG. 7 is graphs illustrating torque for each of different pressing strength onto a screen of a touch pen according to an embodiment;

FIG. 8 is a diagram illustrating an example of an arrangement aspect of a drive unit to a touch pen according to an embodiment;

FIG. 9 is a diagram illustrating another example of an arrangement aspect of a drive unit in a touch pen according to an embodiment;

FIG. 10 is a cross-sectional diagram illustrating another example of an arrangement aspect of a drive unit in a touch pen according to an embodiment;

FIG. 11 is a diagram illustrating another example of an arrangement aspect of a drive unit in a touch pen according to an embodiment;

FIG. 12 is a cross-sectional diagram illustrating another example of an arrangement aspect of a drive unit in a touch pen according to an embodiment;

FIG. 13 is a diagram illustrating characteristics of an organ receptor of a tactile sense on hand skin;

FIG. 14 is a diagram illustrating human auditory characteristics;

FIGS. 15A and 15B are diagrams illustrating power of vibration generated when drawing is performed with a pencil and a ball-point pen;

FIG. 16 is a diagram illustrating drawing areas on a screen of a drawn apparatus according to an embodiment;

FIGS. 17A and 17B are graphs illustrating a spectrum of sound actually generated between a ball-point pen or a pencil and a paper sheet;

FIGS. 18A and 18B are graphs illustrating loudness changes for respective brush-moving speeds and frequencies; and

FIG. 19 is a diagram illustrating an example of a calculation unit of a drawing apparatus according to each embodiment.

### DETAILED DESCRIPTION

According to an embodiment, a drawing apparatus includes a drive unit, a distance acquisition unit, and a drive controller. The drive unit vibrates the drawing apparatus. The distance acquisition unit acquires a distance between the drawing apparatus and a device. The drive controller drives the drive unit at a first amplitude when: the drawing apparatus is in a drawing mode, the drawing apparatus and the device are determined to be within a first distance based on the acquired distance, and the drawing apparatus is determined to be moving. The drive controller drives the drive unit at a second amplitude greater than the first amplitude when: the drawing apparatus is in the drawing mode, the drawing apparatus and the device are determined to be in contact with each other based on the acquired distance, and the drawing apparatus is determined to be moving.

In general, letters or figures are drawn by bringing a pen in contact with a glass surface such as a tablet (hereinafter, simply referred to as drawing), but a pen is likely to slip on a glass surface, resulting in an uncomfortable writing feeling. As a countermeasure to this, for example, an elastomer (such as vulcanized rubber), felt, or the like is used as a material of a pen tip; or a resistance sense-enhancing film is applied on a glass surface such as a tablet.

Furthermore, there exists a technology enabling a user to experience a friction sense when moving a finger along a screen. Thus, a friction sense during an action of moving a finger along a screen is realized. Similarly, in a case of a pen tablet type interface, a technology is known in which surface elastic waves by ultrasonic waves are generated on a screen side to provide resistance in a pen moving direction. Accordingly, roughness is realized. In this case, when vibrating a screen by surface elastic waves in a moving direction of a touch pen and in an opposite direction to the moving direction of a touch pen, easiness and difficulty of movement with respect to a touch pen movement alternately appear. This is sensed as friction. Besides, there are known a method of realizing an adequate friction sense by changing screen vibration strength according to an area of a touch pen being in contact with a screen, as well as a method of calculating vibration behaviors caused by friction between a paper sheet and a touch pen by a simulation and transmitting a similar vibration to a touch pen by vibration of a screen. Moreover, there is disclosed a stylus in which a rotating vibrator or a linear vibrator is vibrated in response to vibration control information from external sources, and the vibration is modulated according to a moving speed of a pointer.

However, when drawing is performed on a glass screen of a tablet, a pen is likely to slip. Accordingly, a soft touch perceived with a writing brush, a painting pencil, or the like is difficult to be achieved. For example, there exists a system enabling a writing brush or a painting brush to be visually displayed on a screen. For example, in an existing product such as Artist Hardware Sensu Brush (registered trademark), a conductive material is used for bristles of a pen so that a screen reacts to an electrostatic touch. Although a state of drawing letters and figures on a glass surface with bristles can be realized, realization of a sense of drawing on an actual paper sheet has not been achieved. A technology of imparting to a user a drawing sense similar to a case of actual description with a writing brush or the like has not been achieved. Therefore, in embodiments described herein, a drawing apparatus capable of achieving a soft drawing tactile feeling like a brush or a painting brush will be described.

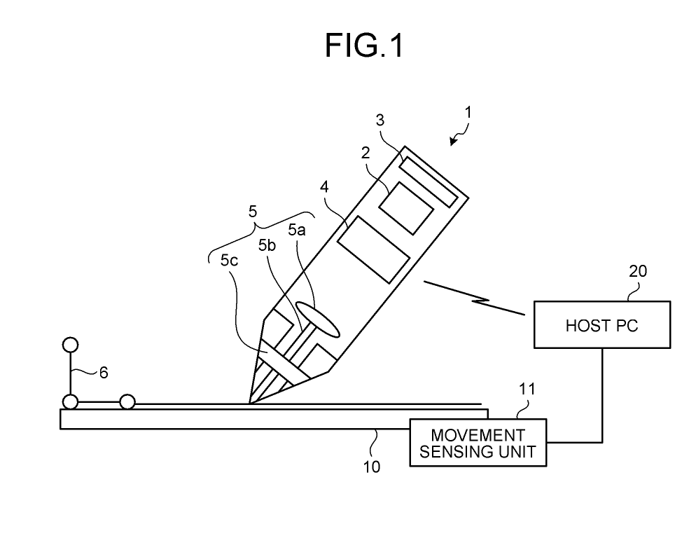

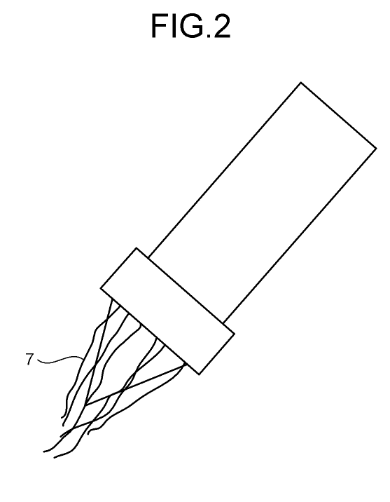

A drawing apparatus according to an embodiment described herein will be described below with reference to drawings. FIG. 1 is a diagram illustrating a hardware configuration of a drawing apparatus. FIG. 2 is a diagram illustrating an aspect of a brush part to be mounted to a tip of a touch pen as a drawing apparatus. As illustrated in FIG. 1, a touch pen 1 as a drawing apparatus includes a drive unit 2, a power source 3, a calculation unit 4 (a drive controller), and a distance sensing unit 5. A brush part 7 as a detachable attachment is mounted to the touch pen 1 shown in FIG. 2. In this case, mounting of the brush part 7 as an attachment is optional. The touch pen 1 is a device for performing drawing to a screen of a drawn apparatus 10 such as a digitizer. The drawn apparatus 10 includes a movement sensing unit 11 that detects drawn coordinates to sense a movement of the touch pen 1. Then, a distance between a pen tip and a screen detected by the distance sensing unit 5 of the touch pen 1 and a position signal from the movement sensing unit 11 are transmitted to a host PC 20 as an information processing apparatus via wired or wireless lines.

The distance sensing unit 5 acquires a distance between a screen and a pen tip, and includes a pen core 5b in the touch pen 1, a conductive rubber 5a mounted to an end of the pen core 5b, and an ultrasonic sensor 5c. The ultrasonic sensor 5c is a three dimensional ultrasonic position sensor in the embodiment described herein. As another method of detecting a distance, an electrostatic capacitance sensor, a PSD (Position Sensing Device), or the like can be used. In a case of an ultrasonic sensor, ultrasonic waves emitted from an ultrasonic oscillator near a pen tip are measured by at least three or more ultrasonic receivers 6 disposed on a screen to calculate a relative three dimensional positional relationship with the screen. These ultrasonic receivers 6 can also be used for detecting a movement of a pen tip on a screen. The power source 3 supplies power to the drive unit 2, the calculation unit 4, the distance sensing unit 5, or the like. The calculation unit 4 controls vibration of the drive unit 2 disposed to the touch pen 1. Furthermore, the calculation unit 4 performs: determination on a drawing mode of the touch pen 1; determination based on information acquired by the movement sensing unit 11, the distance sensing unit 5, and the like; control of output of noise sound; and the like.

The movement sensing unit 11 detects a position of a touch pen by sensing a time change of a pen tip position on a screen of the drawn apparatus 10. A position of the touch pen 1 on a screen is always transmitted to the host PC 20. Usually, a position of a pen tip is measured by the movement sensing unit 11 in a sampling cycle of approximately from tens to 100 Hz. Therefore, a movement of the touch pen 1 is detected by checking changes of pen tip position information transmitted to the host PC 20. In this case, an absolute position of the touch pen 1 on a screen is not necessary, and similarly to a mouse, only a relative movement may be required to be obtained. Movement of the touch pen 1 can also be detected by a compact camera, a PSD (Position Sensing Device), an acceleration sensor, and a gyro sensor each mounted to a pen tip.

The drive unit 2 is hardware for vibrating the touch pen 1. As the drive unit, a motor and a piezoelectric element can be used. In a case of a motor, vibration can be generated by a method of decentering a weight to generate whirl vibration or by alternately switching a forward rotation and a reverse rotation. The drive unit 2 is provided for imparting an adequate friction sense to the touch pen 1. When the drive unit 2 is a motor, a rotation in one direction (forward rotation) and a rotation in a direction opposite to the forward rotation (reverse rotation) may be switched alternately and quickly to generate vibration. Vibration can also be generated by using a decentered weight. However, in such a case, the touch pen 1 entirely vibrates. When the touch pen 1 entirely vibrates with large amplitude, a writing feeling can become uncomfortable. With this vibration, the drive unit 2 enables a user holding the touch pen 1 to experience a sense of performing drawing with a writing brush. A generation method of a writing brush-like sense will be described below.

In a case of a writing brush, when a tip of a brush touches a paper sheet, a letter starts to be written. When a pen tip is a soft body like a writing brush, a force occurring between a paper sheet and a brush tip is minimal. Therefore, a degree of contact is difficult to be detected. Although there is also a method of determining a contact area between brush and glass using an optical or electromagnetic device, a delicate distance from brush becomes difficult to be detected.

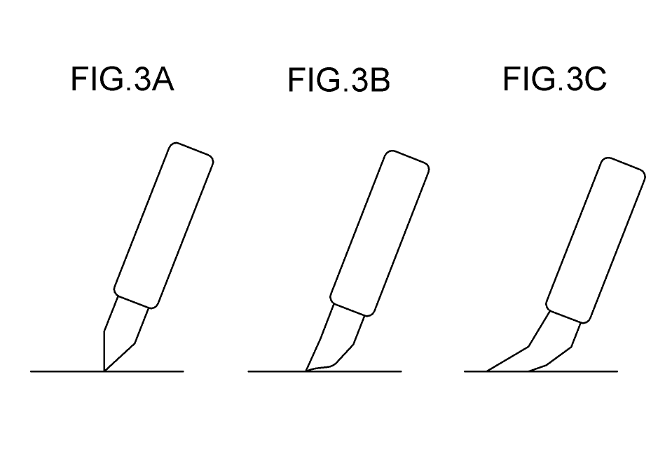

Furthermore, in a case of drawing with a writing brush, a friction sense and a brush movement sense experienced by a user differ depending on states as illustrated in FIGS. 3A to 3C. Here, brush movement refers to a way of moving a brush during performing drawing. Therefore, a brush movement sense is a sense perceived when moving a brush. Such a sense includes, for example, a friction sense with a screen, and a force (a counter force) generated by a counteraction to pressing a screen. In a state of FIG. 3A where only a pen tip is in contact with a screen, a user does not sense a counter force from a screen, but senses a friction sense associated with an action of brush movement. In state of FIG. 3B where a pen tip creeps on a screen, a user senses a counter force from a screen and a friction sense associated with an action of brush movement. In state of FIG. 3C where a pen tip is strongly pressed against a screen resulting in a maximum writing pressure, a user senses resistance to brush movement as well as a counter force from a screen and a friction sense associated with an action of brush movement.

Thus, since a brush movement sense depends on a contact area between a pen tip and a screen, that is a distance between a pen tip and a screen, a user controls a writing pressure while visually and haptically knowing the states in a usual drawing with a writing brush. Therefore, the calculation unit 4 performs control in view of this point when driving the drive unit 2. Specifically, a distance between a pen tip, or the brush part 7 mounted to a pen tip, and a screen is acquired by the distance sensing unit 5. Based on the acquired distance, a driving aspect of the drive unit 2 is controlled.

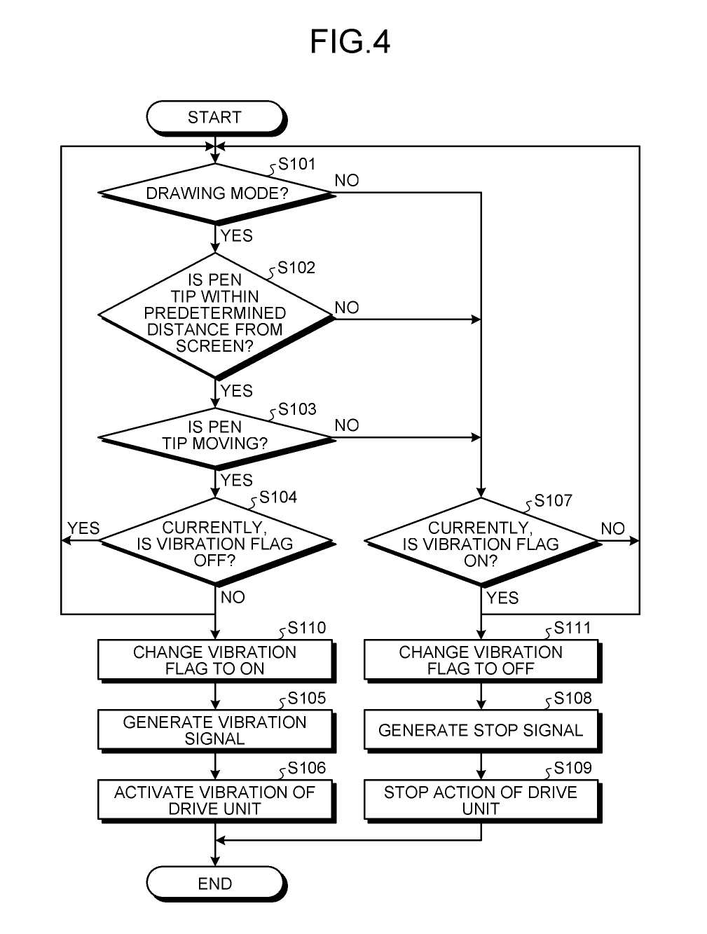

FIG. 4 is a flow chart illustrating a flow of processing of vibration control of the touch pen 1 in the calculation unit 4. First, the calculation unit 4 determines whether or not the touch pen 1 is in a drawing mode (step S101). The drawing mode is a mode that is activated by pressing a drawing mode switch disposed to the touch pen 1 and enables actually-drawn trace to be left on a screen of the drawn apparatus 10. Other methods of switching to a drawing mode may include pressing a drawing mode switch on a screen of the drawn apparatus 10, and automatically activating a drawing mode when a pen tip enters within a drawing area of a screen.

When the touch pen 1 is determined to be in a drawing mode (step S101: Yes), the calculation unit 4 checks output of the distance sensing unit 5 and the movement sensing unit 11 transmitted to the host PC 20, and determines whether or not a pen tip is within a predetermined distance from a screen (step S102), and whether or not the touch pen 1 is moving near a screen (step S103).

When the calculation unit 4 determines that a pen tip is within a predetermined distance from a screen (step S102: Yes), and the touch pen 1 is moving near a screen (step S103: Yes), the calculation unit 4 determines whether or not a vibration flag of the touch pen 1 is OFF (step S104). The vibration flag is a setting information for determining whether or not to vibrate the touch pen 1. When a vibration flag of the touch pen 1 is determined to be OFF (step S104: Yes), a vibration flag is changed to an ON state. Then, the processing returns to step S101 again while moving to step S105 (step S110). Thereafter, the calculation unit 4 generates a predetermined vibration pattern signal (step S105), and transmits the vibration pattern signal to the drive unit 2 for activation (step S106). On the other hand, when vibration is determined not to be in an OFF state (step S104: No), the processing returns to step S101.

On the other hand, when the touch pen 1 is determined not to be in a drawing mode (step S101: No), when a pen tip is determined not to be within a predetermined distance from a screen (step S102: No), and when a pen tip is determined not to be moving (step S103: No), the calculation unit 4 determines whether or not a vibration flag of the touch pen 1 is in an ON state (step S107). When a vibration flag of the touch pen 1 is determined to be in an ON state (step S107: Yes), the calculation unit 4 changes a vibration flag to an OFF state. Then, the processing returns to step S101 again while moving to step S108 (step S111). Thereafter, the calculation unit 4 generates a stop signal (step S108), and transmits a vibration OFF signal to the drive unit 2 for terminating action of the drive unit 2 (step S109). Thus, only when a pen tip is in contact with a screen and moving on the screen, a brush stroke is actually drawn on the screen, and vibration associated with drawing is transmitted to a fingertip. Then, due to the vibration, a user can experience a skin sensation in a fingertip and a motion sense in a hand moving the touch pen 1, and can feel roughness of a screen in contact with the touch pen 1. On the other hand, when a vibration flag of the touch pen 1 is determined not to be in an ON state (step S107: No), the processing returns to step S101.

When a determination on whether or not the touch pen 1 is in a drawing mode (step S101), a determination on whether or not a pen tip is moving (step S103), and a determination on whether or not a pen tip is within a predetermined distance from a screen (step S102) are made on the host PC 20 side, the host PC 20 may generate a vibration pattern of the touch pen 1 in step S105 and step S108, and transmit the generated vibration pattern to the calculation unit 4 of the touch pen 1 via wireless or wired lines. Then, the touch pen 1 having received a vibration pattern performs processing of execution or termination of vibration action of the drive unit 2.

On the other hand, when at least either of a determination on whether or not a pen tip is moving (step S103) and a determination on whether or not a pen tip is within a predetermined distance from a screen (step S102) is made on the touch pen 1 side, a determination on whether or not the touch pen 1 is in a drawing mode (step S101) and a determination on whether or not a vibration flag of the touch pen 1 is in an ON state or in an OFF state (step S104 and step S107) are made on the host PC 20 side. Then, determination results are transmitted to the calculation unit 4 of the touch pen 1.

Therefore, the calculation unit 4 in the touch pen 1 generates an actual vibration pattern or a vibration termination pattern according to a vibration situation of ON or OFF at that time, that is the information acquired from the host PC 20 (steps S105 and S108), to have the drive unit 2 activated/stopped (steps S106 and S109). Notably, when both a determination on whether or not a pen tip is moving (step S103) and a determination on whether or not a pen tip is within a predetermined distance from a screen (step S102) are made on the touch pen 1 side, information to be transmitted from the host PC 20 to the calculation unit 4 in the touch pen 1 is only on whether or not the touch pen 1 is in a drawing mode. That is, only when a mode is to be changed, the mode may be transmitted. At this time, the calculation unit 4 in the touch pen 1 also determines action of the drive unit 2. Notably, in this case, if an ultra-compact camera judging a distance with a screen, or an acceleration or gyro sensor sensing motion of a pen tip is used as the distance sensing unit 5, for example, the host PC 20 needs to transmit only information on whether or not the touch pen 1 is in a drawing mode, and vibration control itself can be performed by the calculation unit 4 in a pen.

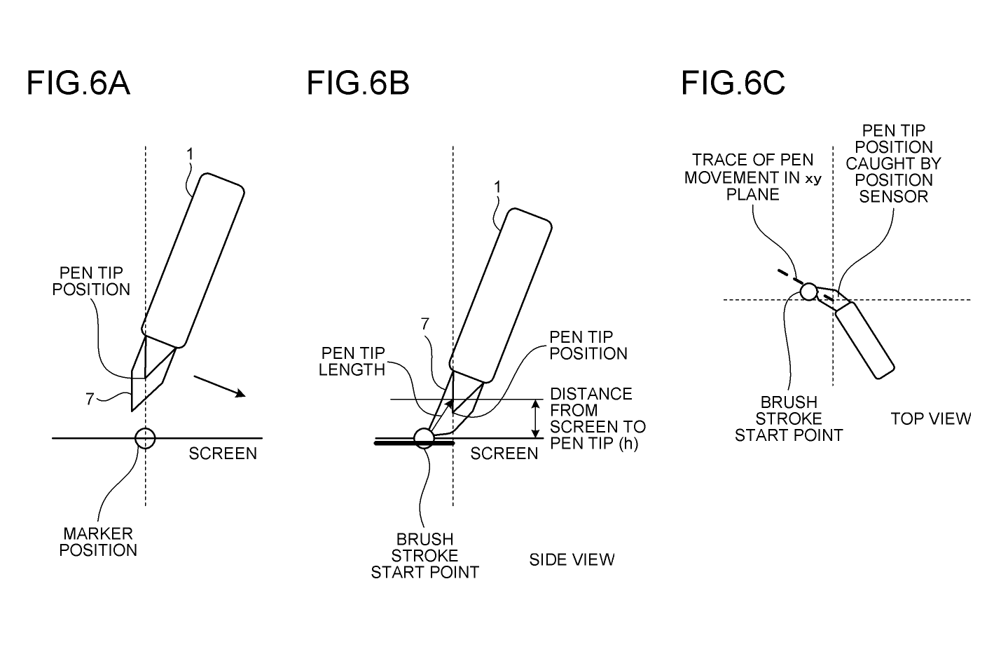

When the brush part 7 is mounted as an attachment as described above, a determination on where a brush stroke starts on a screen is difficult to make. As a countermeasure to this, a marker indicating a position of a pen tip is displayed on a screen so that the position of a pen tip can be recognizable. As a method of displaying a marker, as illustrated in FIGS. 6A to 6C, a sensor senses a position, motion, and a length of a pen tip, as well as a distance between a pen tip and a screen. Accordingly, a position of a marker can be calculated. That is, as illustrated in FIG. 6A, when the brush part 7 is mounted to the touch pen 1, a position of a pen tip and an end of the brush part 7 are different. However, a position of a marker is determined based on a position of a pen tip detected by the movement sensing unit 11. On the other hand, as illustrated in FIGS. 6B and 6C, a starting point of a brush stroke in which drawing is actually started is not a position of a pen tip, but is determined by a position of an end of the brush part 7 and a moving direction of the touch pen 1. Therefore, the touch pen 1 needs to previously have a length information of the brush part 7 to be mounted.

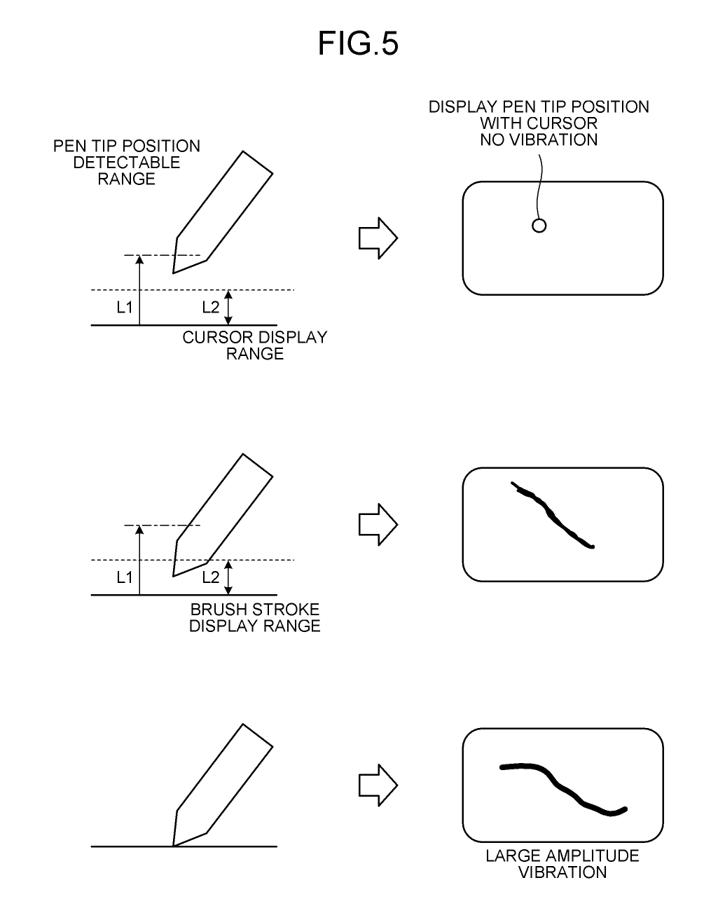

Alternatively, as illustrated in FIG. 5, a brush stroke on a screen may be changed in thickness according to a distance between a pen tip and a screen. For example, distance L1 and distance L2 may be previously stored in the calculation unit 4 as a predetermined distance. When a pen tip is closer than distance L1 and farther than distance L2, only a cursor may be displayed on a screen. When a pen tip becomes closer than distance L2, a cursor may disappear from a screen, and instead a brush stroke may be displayed. And then, when a pen tip contacts with a screen, a further thick brush stroke than that of when a pen tip is located within the distance L2 may be displayed.

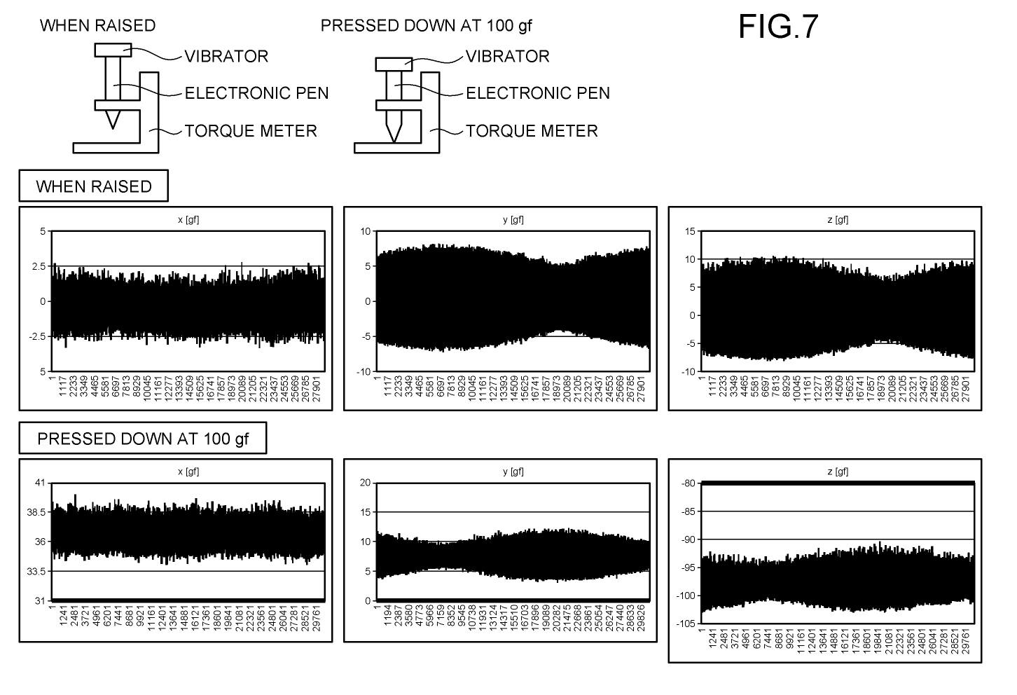

When a pen tip contacts with a screen while vibrating, a pen comes to be in contact with a body of which the mass is much larger than that of a pen. For example, in a case of a 7-inch tablet, the tablet has a weight of approximately 300 to 400 g, while a pen has a weight of around 10 g. Therefore, amplitude which can be experienced may become smaller after contact of the touch pen 1 with a screen, compared to before the contact. FIG. 7 is graphs illustrating variations of a force applied to a pen-holding part when a pen tip is raised up and when a pen tip is pressed against glass at 100 gf, in an existing electronic pen (Wacom Cintiq3 (registered trademark)) equipped with a vibrator. As illustrated in FIG. 7, when a touch pen is pressed against a screen, vibration becomes smaller.

On the other hand, when drawing is actually performed with a brush, resistance to brush movement does not rapidly increase even when a brush touches a screen, due to a buffering action caused by bristles of a brush. Therefore, in order to reduce a rapid change of amplitude between before and after contact of an electronic pen with a screen, vibration amplitude of the drive unit 2 to be applied when a pen comes in contact with a screen is desirably greater than before the contact. Specifically, a plurality of frequencies for vibrating the drive unit 2 is previously stored. When a distance between a screen and a pen tip acquired by the distance sensing unit 5 reaches 0, the calculation unit 4 may perform control to change a frequency for driving the drive unit 2 from small to large. Furthermore, a sensor for measuring a writing pressure may be provided to increase a vibration frequency of the drive unit 2 according to a writing pressure measured by the calculation unit 4.

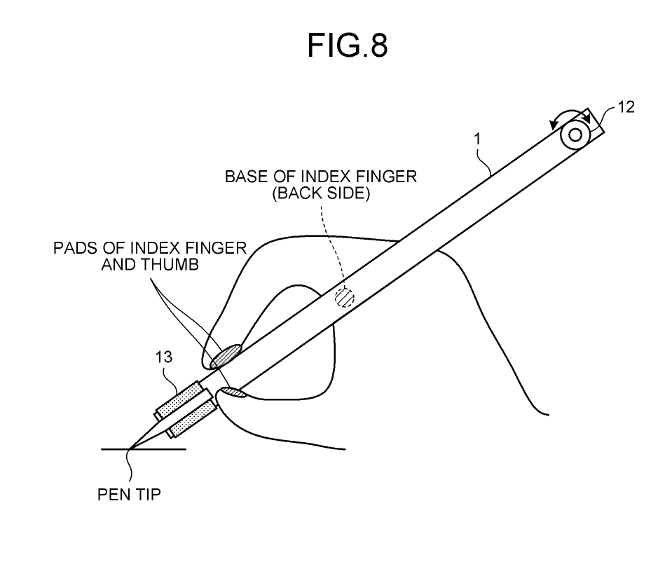

FIG. 8 is a diagram illustrating an example of an arrangement aspect of a drive unit to the touch pen 1. In FIG. 8, a rotating vibrator 12 causing vibration by rotation like a motor is disposed as a drive unit to an end opposite to a pen tip of the touch pen 1. When the rotating vibrator 12 is arranged so that a rotation axis is parallel to an axis of the touch pen 1, a whirling vibration around a pen axis is developed. As a result, vibration is transferred around a base of an index finger supporting the touch pen 1. Here, the rotating vibrator 12 desirably rotates in such a manner that one direction and the other direction indicated in the figure are alternately repeated. Desirably, one direction and the other direction indicated in the figure are alternately repeated. Thus, an aspect of the rotating vibrator 12 rotating in an alternate manner is preferred since a frequency of 10 to 300 Hz can be achieved with a compact apparatus. By providing appropriate frequency, an adequate friction sense can be imparted. Therefore, in this case, by not placing an axis of the rotating vibrator 12 in parallel to an axis of a touch pen and arranging a rotation surface in a direction indicated by arrows in FIG. 8, vibration is transferred to a pad of an index finger and becomes difficult to be transferred to a base of an index finger. Also, by arranging a cushioning material 13 between a pen core and a casing of the touch pen 1, vibration can become difficult to be transferred to a pen core.

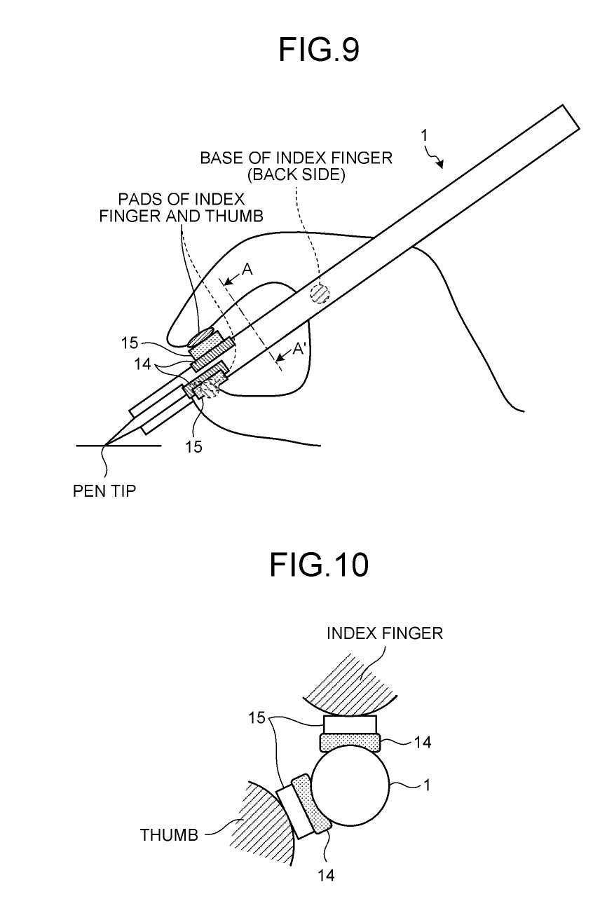

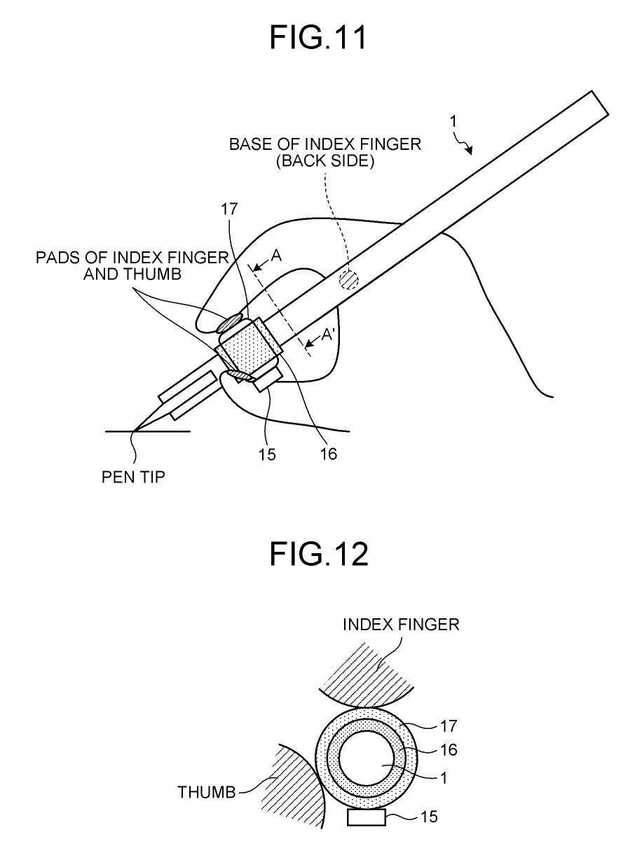

FIG. 9 is a diagram illustrating another example of an arrangement aspect of a drive unit to the touch pen 1. In this example, a vibrator 15 as a drive unit is arranged in a position in contact with at least either of an index finger pad and a thumb pad that hold the touch pen 1. Hence, further arranging a cushioning material 14 between the vibrator 15 and a casing of the touch pen 1 is desirable. FIG. 10 is a cross-sectional diagram of a touch pen and a drive unit. The cushioning material 14 is arranged on an inner side of the vibrator 15 as a drive unit. By arranging the cushioning material 14 in such a position, vibration is transferred to a whole of the touch pen 1. Therefore, decrease easiness of drawing can be inhibited. Also, as illustrated in FIG. 11 and FIG. 12, the vibrator 15 and a ring-like member 17 may be provided. The ring-like member 17 is fitted around the touch pen 1. Vibration from the vibrator 15 is transferred to the ring-like member 17. And then, in order to a whole of the ring-like member 17 vibrates, the vibration can be transferred to a finger when the touch pen 1 is held at any angle. Furthermore, since the number of vibrators does not need to be the number of locations of a support part on a touch pen, the number of components can also be reduced. Also, a cushioning material 16 is disposed between the ring-like member 17 and a casing of the touch pen 1. Also, in a method of directly transferring vibration to a finger by a vibrator, a vibration direction may be any direction.

As described above, in the touch pen 1 of embodiments described herein, vibration is imparted to the touch pen 1 not at a timing when the touch pen 1 contacts with a screen but at a timing when the touch pen 1 is located in a range within a predetermined distance from a screen. As a result, vibration is imparted to the touch pen 1 before actually coming in contact with a screen. Then, when the touch pen 1 touches a screen, amplitude of the vibration is suppressed and reduced by the contact with a screen. Thus, vibration approximated to a friction sense perceived during drawing with a brush can be generated.

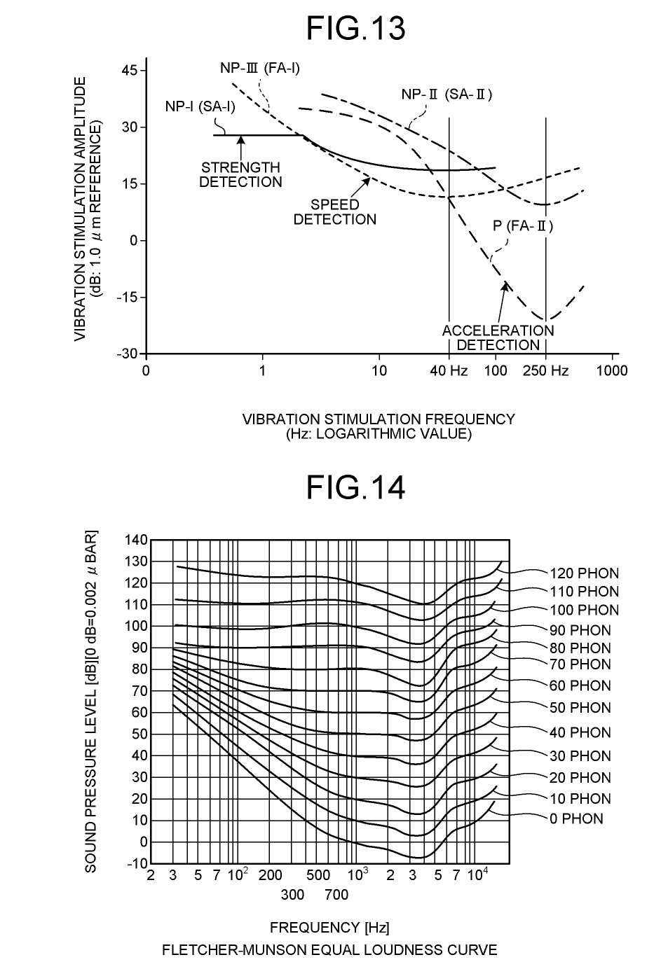

Next, a vibration signal of the drive unit 2 will be described in detail. In FIG. 13, characteristics of an organ receptor of a tactile sense on hand skin is illustrated. There is a mechanoreceptor in a hand palm side of skin. The mechanoreceptor is classified as follows based on a difference of a time change of a response to a skin deformation stimulation as well as characteristics of a receptive field width. The mechanoreceptor is classified into Slowly Adapting (SA) type responding to strength of stimulation and Fast Adapting (FA) type responding to a time change of stimulation, as well as I type having a narrow receptive field and II type having a wide receptive field. NP-1(SA-1) is Merkel cells; NP-2(SA-2) is Ruffini endings; NP-3(FA-1) is Meissner corpuscles; and P(SA-1) is Pacinian corpuscles. Characteristics relating to a skin sense during writing by hand include speed detection, acceleration detection, and strength detection. With respect to speed detection, a peak of sensitivity exists around 40 Hz. Also, with respect to acceleration detection, a peak of sensitivity exists at 250 to 280 Hz.

Meanwhile, FIG. 14 is a diagram illustrating human auditory characteristics. A vertical axis of the graph represents a sound pressure level, and a horizontal axis represents frequency. In the graph, which sound pressure levels are applicable for respective frequencies are assigned for each of 0 to 120 phon as a loudness that can be actually heard by a human ear. The diagram indicates that even at the same sound pressure level, as frequency is higher, larger sound is experienced by a human ear. In human auditory characteristics, sensitivity is low in a low tone range while being high at not lower than 300 Hz. In view of a fact that background noise in a quiet room has a sound pressure of approximately 40 dB, not higher than 30 phon that is an experienced loudness without causing awareness of sound is desired. Furthermore, at least one peak vibration frequency between 10 to 300 Hz is desirably provided so that only vibration can be perceived. In this case, at a vibration frequency of lower than 10 Hz, vibration becomes difficult to be perceived. Therefore, a vibration frequency is preferably at least about 10 Hz.

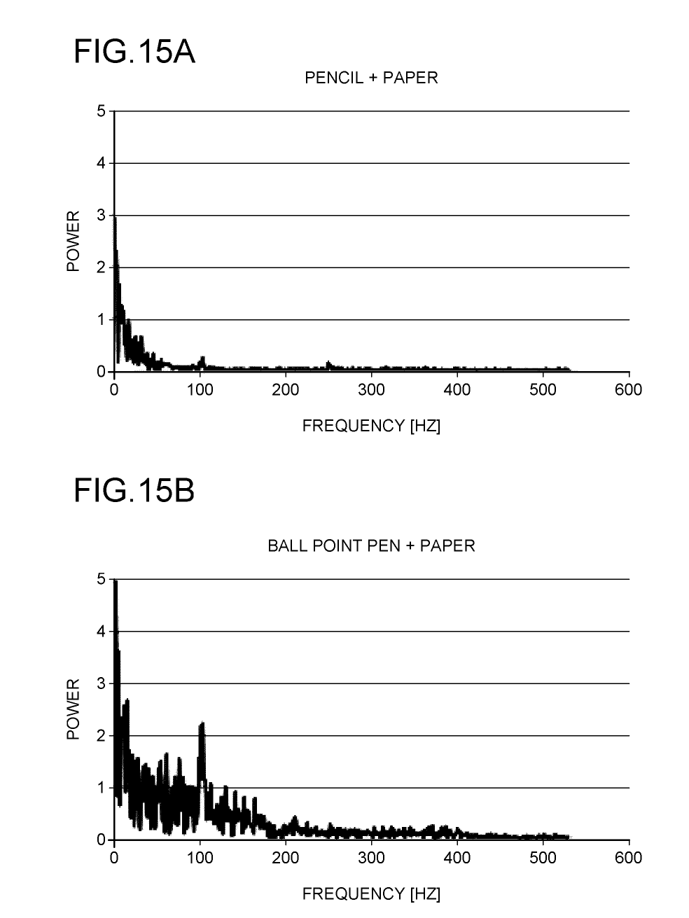

Here, as a touch pen, there is an application of virtually changing a touch pen into one of various types of touch pens such as a pencil, a ball-point pen, and a magic pen. For example, when a user selects a pencil, a tactile sensation of a pencil can be obtained. Also, when a user selects a ball-point pen, a tactile sensation of a ball-point pen can be obtained. For example, FIG. 15A illustrates power versus frequency when a pencil is used as a drawing device and drawing is performed on a paper sheet. Similarly, FIG. 15B illustrates an example when a ball-point pen is used as a drawing device and drawing is performed on a paper sheet. When comparing FIG. 15A with FIG. 15B, regarding a pencil and a ball-point pen, a ball-point pen has larger vibration power. Therefore, the calculation unit 4 is configured to control the drive unit 2 so that vibration becomes a little larger when a user selects a ball-point pen, and vibration becomes a little smaller when a user selects a pencil. Furthermore, a display on a screen may be changed according to a selected touch pen so that drawing with a virtual distinction of a pen type is enabled.

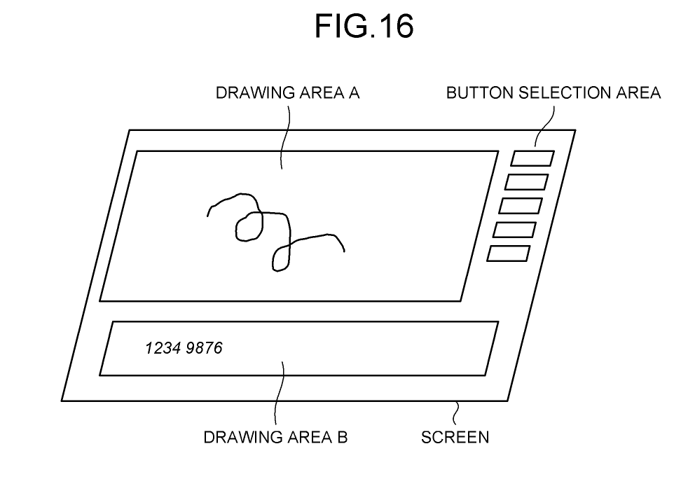

Alternatively, as illustrated in FIG. 16, a region on a screen of the drawn apparatus 10 may be divided into a drawing area A, a drawing area B, and a button selection area. In this case, different vibration patterns may be imparted to respective drawing actions in the drawing area A and the drawing area B. Also, when the button selection area is touched, vibration may not be caused. In this case, these can be realized by changing a vibration pattern to be generated, based on a position information of the movement sensing unit 11 acquired by the calculation unit 4 or the host PC 20. Furthermore, a vibration pattern may be changed according to a line type including vertical and horizontal lines, color, and thickness; a direction (a brush-moving direction) of a stroke that is trace of a touch pen; a position of a displayed object; and the like. For example, by changing the resistance between a touch pen and a screen according to a stroke direction, writing feeling of a new tactile sensation such as virtual directional properties of a paper sheet and a difference in paper quality can be provided. Also, a virtual region can be defined by a writing feeling with a touch pen.

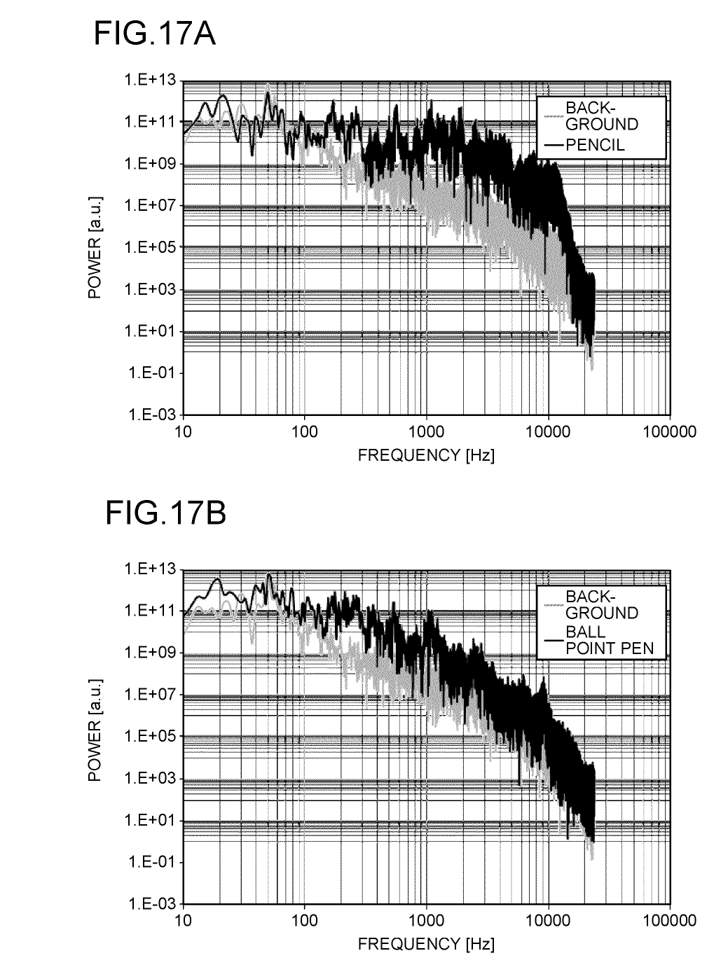

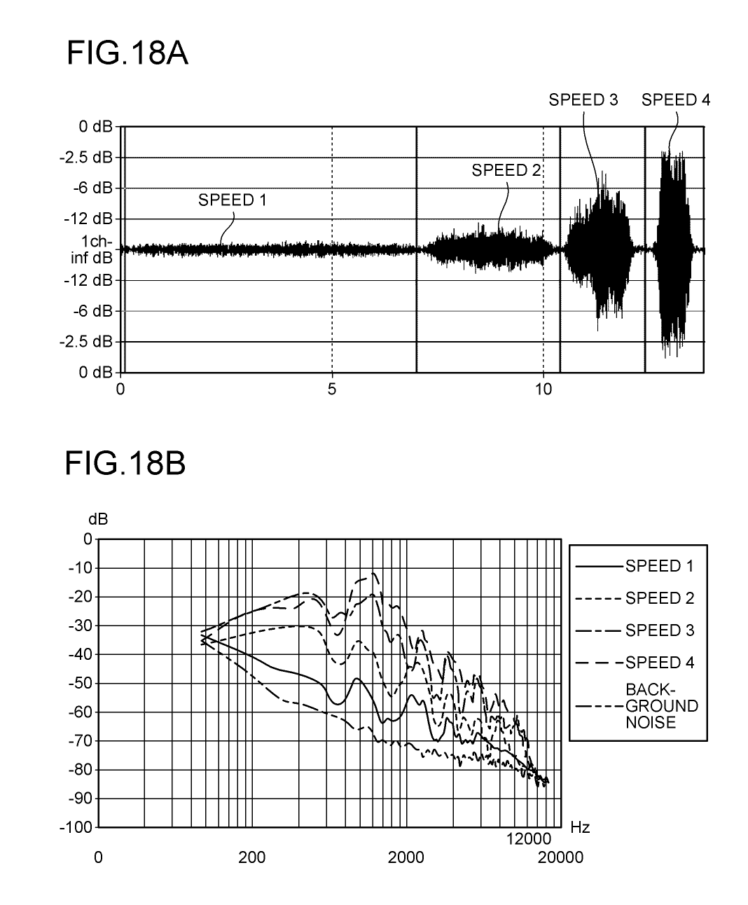

Furthermore, the touch pen 1 may include a sound output unit. The sound output unit is controlled by a sound control unit further provided to the calculation unit 4. For example, in addition to the above-described vibration, random noise sound may be output according to a position of the touch pen 1 in motion, so that a sense of reality can be further increased. FIGS. 17A and 17B are graphs illustrating spectra of sound generated by a paper sheet when a pencil (FIG. 17A) and a ball-point pen (FIG. 17B) are actually used. In brief, the graphs illustrate power versus frequency, and demonstrate random noise sound having random frequency and amplitude. With this random noise sound, a tactile feeling of drawing can be produced by changing loudness and frequency bands according to a moving speed of a touch pen. For example, FIG. 18A is sound data obtained when a line was drawn on a paper sheet with a ball-point pen (Zebra (registered trademark):FLOS). The measurement was performed by changing a brush-moving speed (vertical axis: amplitude, horizontal axis: time, brush-moving speed from left: approximately 20 mm/s, approximately 60 mm/s, approximately 90 mm/s, and approximately 130 mm/s). FIG. 18B is a result of a frequency analysis for each brush-moving speed. As seen from this diagram, with respect to this ball-point pen, a difference in sound pressure level occurs among the speeds in a range of 100 Hz to 12000 Hz with a center around 1 to 2 KHz. Therefore, it is preferable that the calculation unit 4 perform calculation so that a sound pressure level increased or decreased depending on a brush-moving speed in a range of 100 Hz to 12000 Hz with a center around 1 to 2 KHz. The calculation unit 4 adjusts amplitude to become greater as a speed increases. In this case, sound may be increased by 10 to 15 dB as a speed is approximately doubled. Here, sound corresponding to a position of a touch pen can be realized by changing a phase difference between two speakers. By controlling sound, a writing feeling with an increased sense of reality can be obtained. Although a moving speed of a touch pen has been described as an example above, an acceleration, a moving direction (a stroke direction), and the like may be used according to a method of detecting movement.

When a noise having large power on a low band side, such as pink noise, red noise, and brown noise, is used as random noise, a sense close to an actual sound of a touch pen is experienced. By changing this sound according to a touch pen type in a similar manner to vibration, more types of touch pens can be expressed. In order to change a pen type, for example, the touch pen 1 or a tablet screen may be provided with a pen selection button. Each time the button is pressed, a pencil mode, a ball point pen mode, a marker pen mode, a magic pen mode, and the like may be sequentially switched. The method of controlling vibration described herein can also be realized through an attachment to an existing electronic touch pen.

Calculation Unit 4

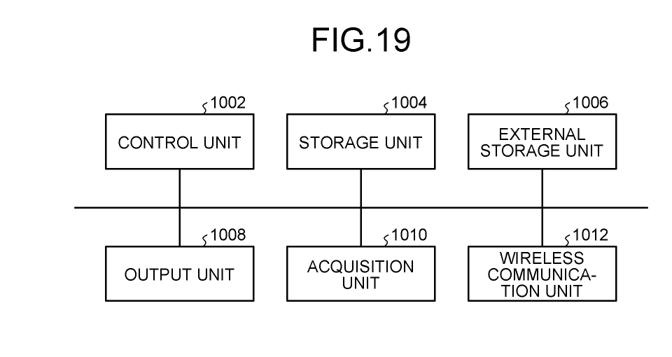

FIG. 19 is a diagram illustrating an example of the calculation unit 4 of the drawing apparatus according to the embodiments above. The calculation unit 4 according to the embodiments above may be built in the touch pen 1, or may be provided to the drawn apparatus 10, the host PC 20, or the like.

When provided to the drawn apparatus 10 or the host PC, the calculation unit 4 includes a control unit 1002 such as a CPU, a storage unit 1004 such as a ROM and a RAM, an external storage unit 1006 such as a HDD, an output unit 1008 outputting information for controlling the drive unit 2 or the sound output unit, and an acquisition unit 1010 acquiring information regarding a moving distance, trace, or the like of the touch pen 1, and configured utilizing a conventional computer. Furthermore, the calculation unit 4 may have an information processing apparatus performing, for example, acquisition of information regarding a moving distance, trace, or the like from the touch pen 1. Especially, when performed via wireless lines or the like, a wireless communication unit 1012 may be provided to the touch pen 1, the drawn apparatus 10, the host PC, and the like.

Processing to be executed in the calculation unit 4 according to the embodiments above may be stored as a program. A program to be interested is provided in a recording medium readable by a computer such as a CD-ROM, a CD-R, a memory card, a DVD (Digital Versatile Disk), and a flexible disk (FD) as a file of an installable or executable format.

Also, a program to be executed in the calculation unit according to the embodiments above may be provided by storing the program on a computer connected to a network such as the Internet and allowing a user to download the program via the network. Also, a program to be executed in the wireless communication unit according to the every above embodiments and every variations may be provided or distributed via a network such as the Internet. Moreover, a program to be executed in the wireless communication unit according to the every above embodiments and every variations may be provided by incorporating previously into a ROM or the like.

A program to be executed in the calculation unit according to the above embodiments has a module structure for realizing the above-described units on a computer. As actual hardware, a CPU retrieves a program from a HDD onto a RAM, and executes the retrieved program to realize the above-described units on a computer.

Here, the above embodiments are not limited by themselves, and can be practiced by modifying the components in a range without departing from the gist in an implementation stage. Also, various inventions can be formed by appropriately combining a plurality of components disclosed in the above embodiments. For example, some components may be deleted from all of the components described in the embodiments. Furthermore, components of different embodiments may be appropriately combined.

For example, the each steps in the flow chart of the embodiments above may be changed in execution order, may be plurally executed in a simultaneous manner, or may be executed in a different order for every implementation, unless such changes or execution are contrary to the nature of the steps.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A drawing apparatus comprising:
a drive unit configured to vibrate the drawing apparatus;
a distance acquisition unit configured to acquire a distance between the drawing apparatus and a device; and
a drive controller configured to:
drive the drive unit at a first amplitude when:
the drawing apparatus is in a drawing mode,
the drawing apparatus and the device are predetermined to be within a first distance based on the acquired distance, and the drawing apparatus is determined to be moving; and drive the drive unit at a second amplitude greater than the first amplitude when:
the drawing apparatus is in the drawing mode;
the drawing apparatus and the device are determined to be in contact with each other based on the acquired distance; and the drawing apparatus is determined to be moving.

2. The drawing apparatus of claim 1, wherein
the drive controller is configured to stop driving of the drive unit when at least one of:
the drawing apparatus is not in the drawing mode; and
the drawing apparatus is determined not to be moving.

3. The drawing apparatus of claim 1, wherein
the drive unit has at least one peak vibration frequency between 10 to 300 Hz.

4. The drawing apparatus of claim 1, further comprising a cushioning material between the drive unit and a casing of the drawing apparatus configured to reduce a transfer of vibration caused by the drive unit.

5. The drawing apparatus of claim 1, wherein
the drive unit comprises a rotating vibrator configured to vibrate while alternately changing rotation directions.

6. The drawing apparatus of claim 1, wherein
the drive controller is configured to control a vibration pattern that causes the drive unit to vibrate, according to a selected drawing apparatus type.

7. The drawing apparatus of claim 1, further comprising:
a sound output unit configured to generate sound during movement of the drawing apparatus.

8. The drawing apparatus of claim 7, further comprising:
a sound controller configured to control the sound output unit, wherein
the sound controller is configured to change at least one of an amplitude and a frequency of the sound according to at least one of a speed, an acceleration, and a direction of sensed movement of the drawing apparatus.

9. The drawing apparatus of claim 8, wherein
the sound controller is configured to change at least one of the amplitude and the frequency of the sound according to a selected drawing apparatus type.

10. A drawing system, comprising:
a drawing apparatus;
a device including a screen on which the drawing apparatus is configured to draw; and
an information processing apparatus configured to communicate between the drawing apparatus and the drawn apparatus, wherein
the drawing apparatus comprises:
a drive unit configured to vibrate the drawing apparatus;
a distance acquisition unit configured to acquire a distance between the drawing apparatus and the screen; and
a drive controller configured to:
drive the drive unit at a first amplitude when:
the drawing apparatus is in a drawing mode,
the drawing apparatus and the screen are determined to be within a first distance based on the acquired distance, and
the drawing apparatus is determined to be moving, and
drive the drive unit at a second amplitude greater than the first amplitude when:
the drawing apparatus is in the drawing mode,
the drawing apparatus and the screen are determined to be in contact with each other based on the acquired distance, and the drawing apparatus is determined to be moving.
